(19) United States
(12) Patent Application Publication
(10) Pub. No.: US 2006/0037709 A1
(43) Pub. Date: Feb. 23, 2006

(54) Label attaching apparatus which attaches a label to external peripheral surface of a test tube

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS Co., Ltd., Kumamoto (JP)

(21) Appl. No.: 11/195,591

(22) Filed: Aug. 3, 2005

(30) Foreign Application Priority Data
Aug. 20, 2004 (JP) 2004-240803

(51) Int. Cl. B32B 37/00; B65C 3/12; B65C 9/04

(52) U.S. Cl. 156/446; 156/556

(57) ABSTRACT

A label attaching apparatus includes a supplying mechanism, an attaching mechanism, and a label supplying mechanism. The supplying mechanism has a holding mechanism which holds a test tube in a standing attitude, and an elevating mechanism which moves up and down the holding mechanism between an attaching position and a waiting position in which the holding mechanism is receded above from the attaching position. The attaching mechanism rotates the test tube having been moved down to the attaching position in a circumferential direction of the test tube, and attaches a label to an external peripheral surface of the test tube by winding the label around the external peripheral surface. The label supplying mechanism supplies the label to the attaching mechanism.

### CROSS-REFERENCE TO RELATED APPLICATIONS

This application is based upon and claims the benefit of priority from prior Japanese Patent Application No. 2004-240803, filed Aug. 20, 2004, the entire contents of which are incorporated herein by reference.

### BACKGROUND OF THE INVENTION

1. Field of the Invention

This invention relates to a label attaching apparatus which automatically attaches an identification label to an external peripheral surface of a test tube containing a sample such as blood.

2. Description of the Related Art

In medical institutions such as hospitals, drawn blood is contained in test tubes. The date and time of blood drawing, and personal information such as the name, sex, and age of a person from whom the blood is drawn are indicated by a bar code and the like. Bar codes are printed on identification labels such as bar code labels. Identification labels are attached to external peripheral surfaces of test tubes.

Jpn. U.M. Appln. KOKAI Pub. No. 6-46810 discloses a label attaching apparatus which automatically attaching identification labels to external peripheral surfaces of test tubes. The conventional label attaching apparatus comprises supplying means, attaching means, and determination means.

The supplying means sends a plurality of test tubes contained in a cassette to attaching means one by one. The attaching means rotates each test tube sent from the supplying means in a circumferential direction of the test tube, and attaches an identification label to an external peripheral surface of the test tube. The determination means monitors the attaching state of the identification label to each test tube, and reads a bar code from each identification label. When it determines that the attaching state of the identification label and the reading result of the bar code are defective, the determination means removes the test tube whose attaching state of the identification label has been determined as defective.

The conventional label attaching apparatus has a structure wherein test tubes consistently maintain a horizontal attitude during a period from being sent out from the cassette to determination of the attaching state of the identification label. Therefore, the supplying means, the attaching means and the determination means must be separate and individual units, and be arranged on the same plane with intervals from one another.

This increases a planar dimension of the label attaching apparatus, and requires a large installation space for the apparatus. Further, the apparatus requires means dedicated to conveyance of the test tubes from the supplying means to the determination means via the attaching means, as an indispensable element. This causes the problem that the label attaching apparatus has a complicated structure and a large scale, and thus the price of the label attaching apparatus is increased.

### BRIEF SUMMARY OF THE INVENTION

The object of the present invention is to obtain a label attaching apparatus which enables reduction in space required for installation of the apparatus, and a simplified structure and low price.

To achieve the above object, a label attaching apparatus according to an aspect of the present invention comprises supplying means, attaching means, and a label supplying mechanism. The supplying means has a holding mechanism which holds a test tube in a standing attitude in an attaching position, and an elevating mechanism which moves up and down the holding mechanism between the attaching position and a waiting position in which the holding mechanism is receded above from the attaching position. The attaching means rotates the test tube having been moved down to the attaching position in a circumferential direction of the test tube, and attaches a label to an external peripheral surface of the test tube by winding the label around the external peripheral surface. The label supplying mechanism supplies the label to the attaching mechanism.

According to the above structure, it is possible to perform a series of operations from supply of a test tube to attachment of an identification label in the state where the test tube has a vertical attitude. Therefore, it is possible to reduce the space required for installation of the label attaching apparatus in comparison with the prior art.

In addition, attaching a label to a test tube can be achieved only by vertically moving the test tube between the attaching position and the waiting position. This eliminates the need for the means dedicated to conveyance of the test tubes for each operation step. Therefore, the structure of the label attaching apparatus is simplified, and thus the cost of facilities can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic plan view illustrating a label attaching apparatus according to an embodiment of the present invention.

FIG. 2A is a side view of the label attaching apparatus according to the embodiment of the present invention, illustrating a positional relationship among a test tube, supplying means, attaching means, a conveying mechanism and a label supplying mechanism.

FIG. 2B is a cross-sectional view of a holding mechanism which holds the test tube in a vertically standing attitude.

FIG. 3 is a plan view of the label attaching apparatus according to the embodiment of the present invention, illustrating a positional relationship among the test tube, the attaching means and the label supplying mechanism.

FIG. 4 is a plan view of the label attaching apparatus according to the embodiment of the present invention, illustrating a state where the test tube is held in the vertically standing attitude via upper rotating members and lower rotating members.

FIG. 5 is a side view of the label attaching apparatus according to the embodiment of the present invention, illustrating the state where the test tube is held in the vertically standing attitude via the upper rotating members and the lower rotating members.

### DETAILED DESCRIPTION OF THE INVENTION

An embodiment of the present invention will be explained below with reference to drawings.

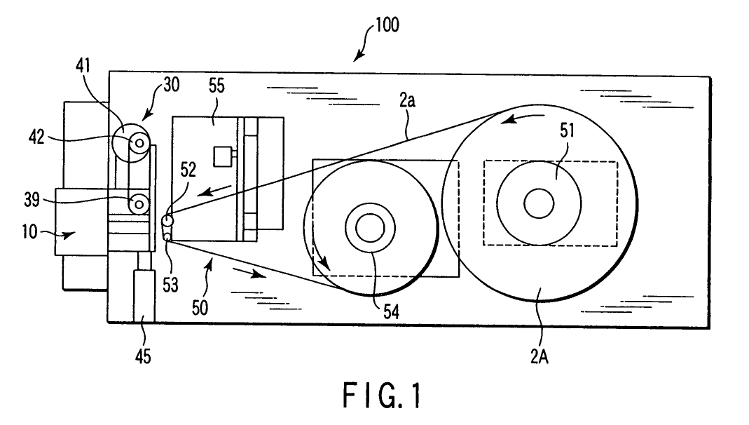

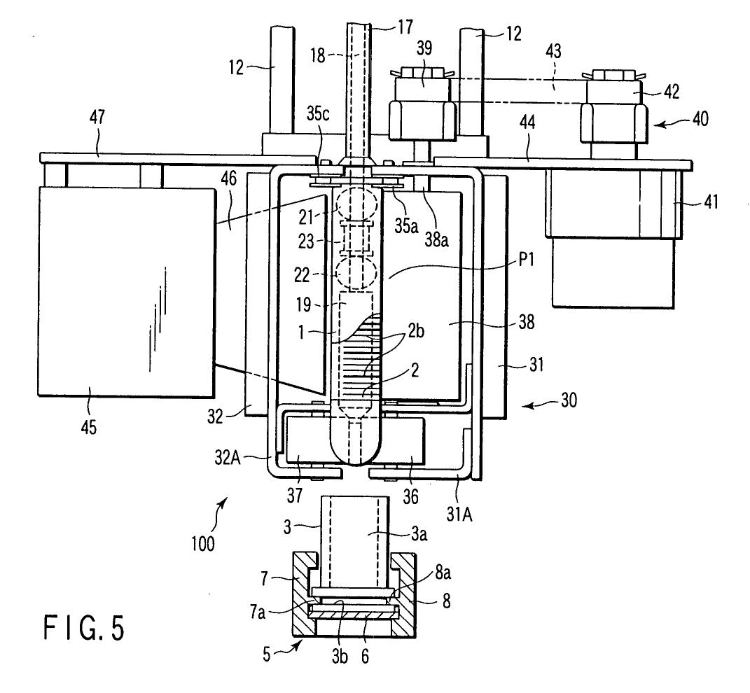

FIG. 1 is a schematic plan view of a label attaching apparatus 100 according to the present invention. The label attaching apparatus 100 automatically attaches a bar-code label 2 as shown in FIG. 5 to an external peripheral surface of a test tube 1. The barcode label 2 has a bar code 2b indicating information of a sample to be contained in the test tube 1. The bar code 2b is printed on the bar-code label 2.

The label attaching apparatus 100 has an attaching position P1 in which the bar code label 2 is attached to the test tube 1. Supplying means 10, attaching means 30 and label supplying mechanism 50 are centralized in the attaching position P1.

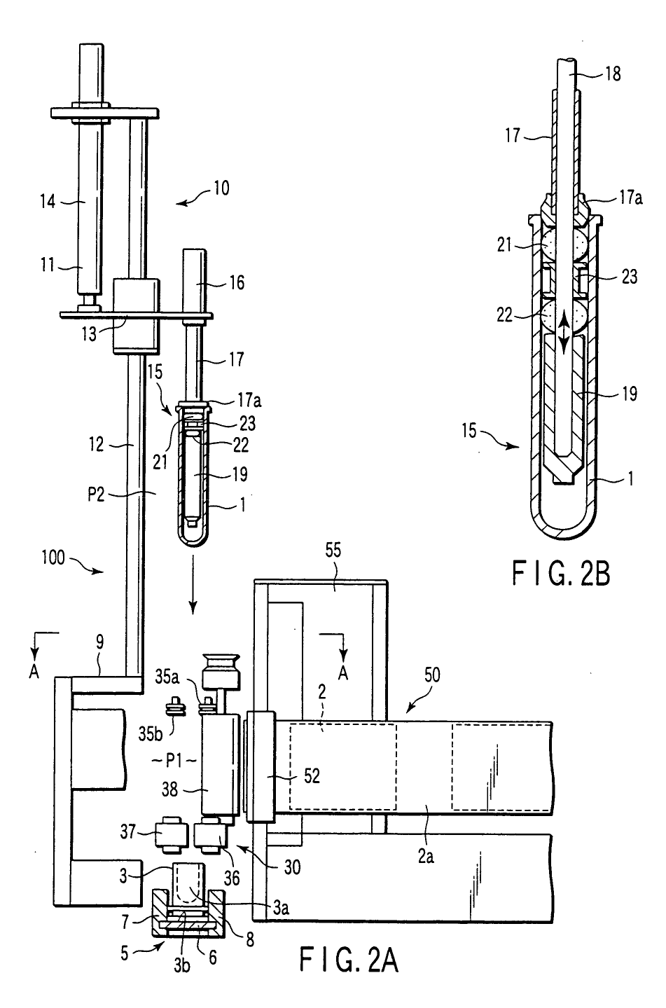

As shown in FIG. 2A, the supplying means 10 is provided above the attaching position P1. The supplying means 10 has an elevating mechanism 11, and a holding mechanism 15 supported by the elevating mechanism 11. The elevating mechanism 11 has a frame 9, a pair of guide rails 12 which vertically stand from the frame 9, an elevating member 13 which is vertically movably supported by the guide rails 12, and a first cylinder 14 which moves up and down the elevating member 13 at predetermined strokes. In other words, the first cylinder 14 of the elevating mechanism 11 is configured to move up and down the holding mechanism 15 between the attaching position P1 and a waiting position P2 in which the holding mechanism 15 is receded above from the attaching position P1.

The holding mechanism 15 holds the test tube 1 in a vertically standing attitude. The holding mechanism 15 has a guide tube 17 and a second cylinder 16. The guide tube 17 is secured to the elevating member 13, and projects vertically downward from the elevating member 13. The guide tube 17 has, at its bottom end, a fitting portion 17a to be fitted into an opening end of the test tube 1.

The second cylinder 16 is held in a vertically standing attitude on the elevating member 13. The second cylinder 16 has an axially movable rod 18. As shown in FIG. 2B, the rod 18 goes through the guide tube 17 and the fitting portion 17a and projects downward from the guide tube 17. An insertion guide 19 to be inserted into the test tube 1 is fixed onto the projecting end portion of the rod 18.

Further, a pair of elastic members 21 and 22 and a pressing member 23 are provided on the rod 18. Each of the elastic members 21 and 22 has a spherical shape of a size which can be inserted into the test tube 1. The elastic members 21 and 22 are located between the fitting portion 17a and the insertion guide 19, and movable with respect to the rod 18 in the axial direction of the rod 18. The pressing member 23 is a bobbin having a size which can be inserted into the test tube 1. The pressing member 23 is located between the elastic members 21 and 22 and movable with respect to the rod 18 in the axial direction of the rod 18.

When the holding mechanism 15 is receded in the waiting position P2, the test tube 1 is automatically supplied to a position below the holding mechanism 15 by a test tube supplying device (not shown). In this operation, the test tube 1 is held in a vertical attitude with its opening end upward.

The first cylinder 14 of the elevating mechanism 11 moves down the holding mechanism 15 from the waiting position P2 to the attaching position P1 when the test tube 1 is supplied to a position below the holding mechanism 15. Thereby, as shown in FIG. 2B, the fitting portion 17a located at the bottom end of the guide tube 17 is fitted into the opening end of the test tube 1, and the insertion guide 19, the elastic members 21 and 22 and the pressing member 23 on the rod 18 are inserted into the test tube 1.

When the insertion guide 19, the elastic members 21 and 22 and the pressing member 23 have been inserted into the test tube 1, the second cylinder 16 of the holding mechanism 15 moves the rod 18 in a direction of being pulled out of the test tube 1. By this movement, the insertion guide 19 is raised in the test tube 1, and the interval between the insertion guide 19 and the fitting portion 17a is narrowed. Therefore, one elastic member 21 is compressed between the fitting portion 17a and the pressing member 23, and the other elastic member 22 is compressed between the pressing member 23 and the insertion guide 19.

Thus, the elastic members 21 and 22 are compressed to increase in its diameter inside the test tube 1, and thereby the external peripheral surfaces of the elastic members 21 and 22 closely contact the internal surface of the test tube 1. As a result, the test tube 1 is held in the vertically standing attitude by the elastic members 21 and 22.

When the second cylinder 16 moves the rod 18 in a direction of being pushed into the test tube 1, the interval between the insertion guide 19 and the fitting portion 17a is widened. Therefore, the elastic members 21 and 22 are released from compression, and return to their original shapes. Thereby, the elastic members 21 and 22 separate from the internal surface of the test tube 1, and the test tube 1 is released from holding by the elastic members 21 and 22.

In the embodiment, the pair of elastic members 21 and 22 hold the test tube 1 in the vertically standing attitude. However, the present invention is not limited to it, but the test tube 1 may be held by a single elastic member. According to this structure, the single elastic member is compressed between the insertion guide 19 and the fitting member 17a, and thus the pressing member 23 can be omitted.

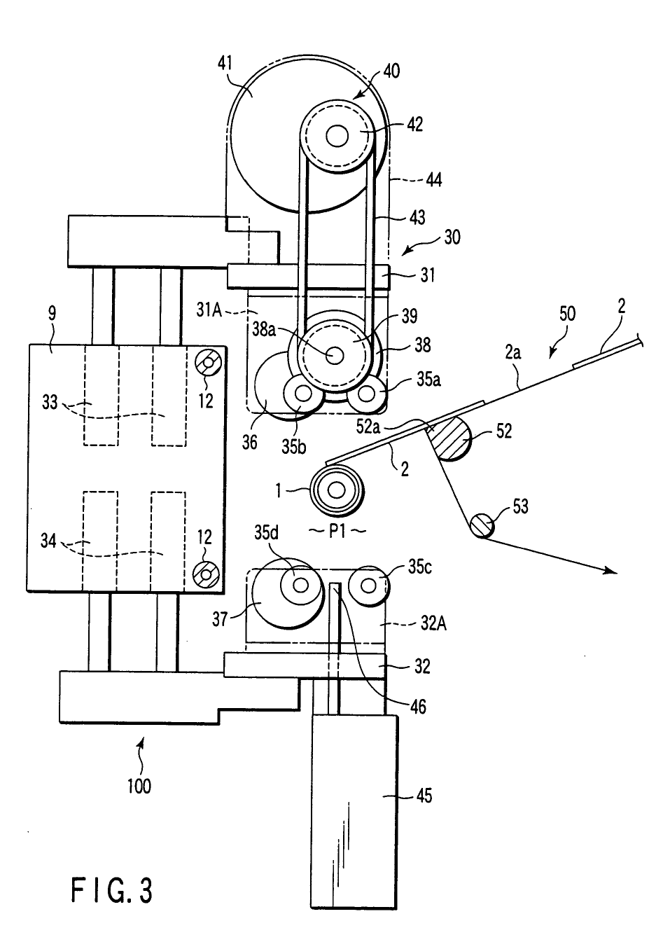

The attaching means 30 attaches the bar-code label 2 to the test tube 1 moved down to the attaching position P1, by winding the bar-code label 2 around the test tube 1. As shown in FIGS. 3 to 5, the attaching means 30 has a first and a second movable members 31 and 32, and a plurality of drive cylinders 33 and 34. The first and second movable members 31 and 32 are opposed to each other, with the test tube 1 in the attaching position P1 interposed therebetween. The drive cylinders 33 move the first movable member 31 in directions of approaching and going away from the test tube 1. The drive cylinder 34 moves the second movable member 32 in directions of approaching and going away from the test tube 1.

The first movable member 31 has a first bracket 31A projecting downward. In the same manner, the second movable member 32 has a second bracket 32A projecting downward. The first and second brackets 31A and 32A are opposed to each other, with the test tube 1 in the attaching position P1 interposed therebetween.

The first bracket 31A has a pair of upper rotating members 35a and 35b and a lower rotating member 36. The upper rotating members 35a and 35b are pulleys, for example, and rotatably supported on a top end of the first bracket 31A. The lower rotating member 36 is a roller, for example, and rotatably supported on a bottom end of the first bracket 31A.

The second bracket 32A has a pair of upper rotating members 35c and 35d, and a lower rotating member 37. The upper rotating members 35c and 35d are pulleys, for example, and rotatably supported on a top end of the second bracket 32A. The lower rotating member 37 is a roller, for example, and rotatably supported on a bottom end of the second bracket 32A.

The upper rotating members 35a to 35d rotatably hold an external peripheral surface in an upper end of the test tube 1, when the first and second movable members 31 and 32 move in the direction of approaching the test tube 1. In the same manner, the lower rotating members 36 and 37 rotatably hold the external peripheral surface in a lower end of the test tube 1, when the first and second movable members 31 and 32 move in the direction of approaching the test tube 1. Therefore, the test tube 1 which has been moved down to the attaching position P1 is supported by the four upper rotating members 35a to 35d and the two lower rotating members 36 and 37 such that it is movable in the circumferential direction thereof.

As shown in FIGS. 3 to 5, the first bracket 31A has a label attaching roller 38. The label attaching roller 38 is rotatably supported in a vertically standing attitude by the first bracket 31A. The label attaching roller 38 is brought into rolling contact with the external peripheral surface of the test tube 1, when the test tube 1 is supported by the upper rotating members 35a to 35d and the lower rotating members 36 and 37.

As shown in FIG. 5, the label attaching roller 38 has a rotation shaft 38a projecting upward. A follower pulley 39 is provided on an upper end portion of the rotation shaft 38a. Further, a motor 41 is supported by the first bracket 31A with a support plate 44 interposed therebetween. The motor 41 has a drive pulley 42. A gearing belt 43 runs between the drive pulley 42 and the follower pulley 39. The gearing belt 43 transmits a torque of the motor 41 to the label attaching roller 38 through the drive pulley 42 and the follower pulley 39.

Therefore, the follower pulley 39, the drive pulley 42, the gearing belt 43, and the motor 41 form a roller drive mechanism 40 which rotates the label attaching roller 38 in its circumferential direction.

The label supplying mechanism 50 intermittently supplies the bar-code label 2 between the external peripheral surface of the test tube 1 and the label attaching roller 38. As shown in FIGS. 1, 3 and 4, the label attaching mechanism 50 comprises a feeding device 51, a wind-up device 54, a separating shaft 52, a guide roller 53 and a label printer 55.

The feeding device 51 rotatably supports a roll 2A formed by winding up a label sheet 2a. The label sheet 2a is fed from the feeding device 51 toward the attaching position P1.

The wind-up device 54 intermittently winds the label sheet 2a fed from the feeding device 51 according to a predetermined process. The separating shaft 52 inverts the feeding direction of the label sheet 2a, which is going from the feeding device 51 to the attaching position P1, toward the wind-up device 54. The separating shaft 52 is adjacent to the test tube 1 standing in the attaching position P1. The guide roller 53 is located next to the separating shaft 52, and guides the label sheet 2a which has passed the separating shaft 52 to the wind-up device 54.

The label printer 55 produces the bar-code label 2 on which the bar code 2b is printed. The produced barcode label 2 is attached to the label sheet 2a at a position on the feeding device 51 side of the separating shaft 52, that is, upstream of the separating shaft 52.

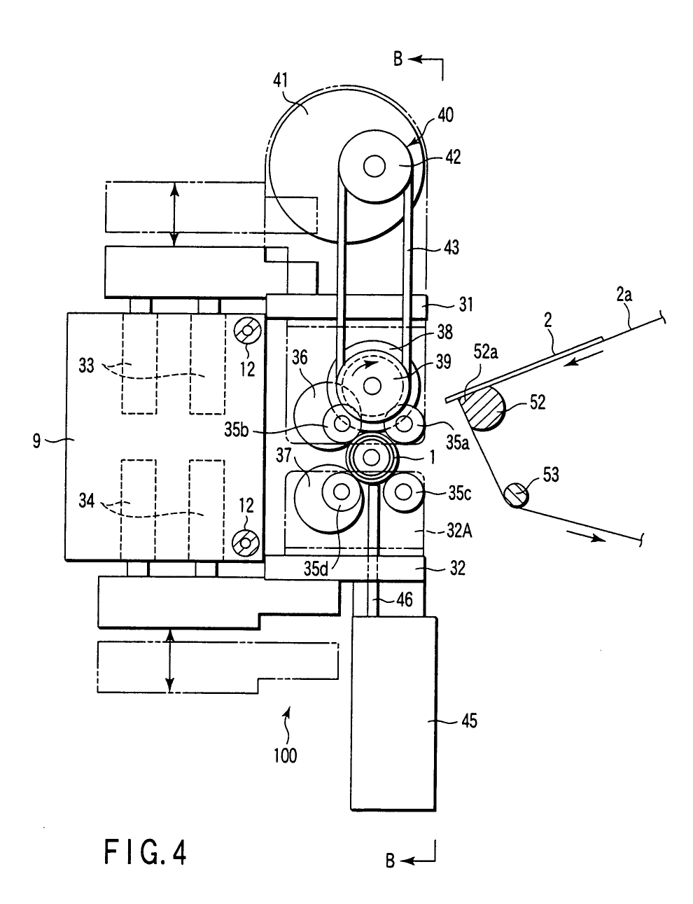

As shown in FIGS. 3 and 4, the separating shaft 52 has a corner portion 52a which is tapered down toward the attaching position P1. The label sheet 2a fed from the feeding device 51 is turned at an acute angle along the corner portion 52a at the separating shaft 52.

Therefore, when the bar-code label 2 attached to the label sheet 2a reaches the separating shaft 52, the label sheet 2a is compulsorily pulled in a direction away from the bar-code label 2. In other words, the bar-code label 2 is peeled from the label sheet 2a, and the peeled bar-code label 2 is fed between the external peripheral surface of the test tube 1 and the label attaching roller 38. In this step, the bar-code label 2 is positioned such that its back surface having an adhesive layer faces the external peripheral surface of the test tube 1.

As shown in FIG. 5, a bar-code reader 45 is supported by the second bracket 32A of the attaching means 30, with a support plate 47 interposed therebetween. The bar-code reader 45 reads the bar code 2b from the bar-code label 2 attached to the test tube 1. The bar-code reader 45 has a light projecting port 46, and a lamp (not shown) which emits light when the bar code reader 45 reads the bar code 2b.

The bar-code reader 45 determines whether the attaching state of the bar-code label 2 to the test tube 1 is good or defective, on the basis of the reading result of the bar code 2b. If it determines that the attaching state of the bar-code label 2 is defective, the bar-code reader 45 outputs a signal for eliminating the test tube 1 having the defective barcode label 2.

As shown in FIGS. 2A and 5, a conveying mechanism 5 is provided below the attaching position P1. The conveying mechanism 5 conveys the test tube 1 with the bar-code label 2 attached to the following process position. The conveying mechanism 5 comprises a plurality of holders 3 each of which receive the test tube 1, a belt conveyer 6, and a pair of guide plates 7 and 8.

Each holder 3 comprises a cylindrical portion 3a into which a bottom end portion of the test tube 1 is inserted, and a guide groove 3b formed in a bottom end portion of the cylindrical portion 3a. The guide groove 3b has an annular shape continuing in the circumferential direction of the cylindrical portion 3a.

The belt conveyer 6 intermittently conveys the holders 3. The belt conveyer 6 temporarily stops when one holder 3 reaches directly under the attaching position P1.

The guide plates 7 and 8 are opposed to each other, holding the belt conveyer 6 therebetween, and are provided along the belt conveyer 6. The guide plates 7 and 8 have guide projections 7a and 8a, respectively. The guide projections 7a and 8a extend along the belt conveyer 6, and are slidably fitted into the guide groove 3b of the holder 3. By this fitting, the holder 3 is held in an attitude such that the cylindrical portion 3a thereof stands upright.

FIGS. 2A and 5 illustrate that the conveying mechanism 5 is close to the lower rotating members 36 and 37 of the attaching means 30. However, in the actual label attaching apparatus 100, a space exists between the lower rotating members 36 and 37 and the conveying mechanism 5. The space has a vertical length larger than the whole length of the test tube 1.

The space receives a recovery box (not shown) which recovers test tubes 1 whose attaching states of the bar-code label 2 are defective. The recovery box is movable between a first position in which the box is withdrawn from the space and a second position in which the box enters the space to reach directly under the attaching means 30. In other words, the recovery box moves from the first position to the second position, when the bar-code reader 45 has outputted a signal indicating that the attaching state of the bar-code label 2 is defective.

Next, operation of the label attaching apparatus 100 is explained.

FIG. 2A illustrates the state where the test tube 1 is held in the waiting position 2 in the vertically standing attitude. When the first cylinder 14 of the elevating mechanism 11 moves down the elevating member 13, the test tube 1 moves from the waiting position P2 to the attaching position P1, while maintaining the vertical attitude. At the time when the test tube 1 is moved down, the first and second movable members 31 and 32 are away from the attaching position P1. Therefore, as shown in FIG. 3, the upper rotating members 35a and 35b and the lower rotating member 36 of the first movable member 31 and the upper rotating members 35c and 35d and the lower rotating member 37 of the second movable member 32 are away from the external peripheral surface of the test tube 1, so as not to prevent the test tube 1 from moving down.

When the test tube 1 has been moved down to the attaching position P1, the wind-up device 54 of the label supplying mechanism 50 operates. Thereby, the label sheet 2a is fed from the roll 2A supported by the feeding device 51. Together with this, the bar-code label 2 produced by the label printer 55 is attached to the label sheet 2a located on the feeding device 51 side of the separating shaft 52, that is, upstream of the separating shaft 52.

When the bar-code label 2 reaches the separating shaft 52 with feeding of the label sheet 2a, the barcode label 2 is peeled from the label sheet 2a. The peeled bar-code label 2 is guided to the test tube 1 standing in the attaching position P1, and the back surface of the bar-code label 2 having the adhesive layer faces the external peripheral surface of the test tube 1, as shown in FIG. 3.

Next, as shown in FIG. 4, the first and second movable members 31 and 32 are advanced to the test tube 1 by the drive cylinders 33 and 34. By this advance, the upper rotating members 35a to 35d rotatably hold the upper end portion of the test tube 1, and the lower rotating members 36 and 37 rotatably hold the lower end portion of the test tube 1. Further, the label attaching roller 38 is advanced to the external peripheral surface of the test tube 1, and the bar-code label 2 peeled from the label sheet 2a is held between the label attaching roller 38 and the external peripheral surface of the test tube 1.

When the test tube 1 is held by the upper rotating members 35a to 35d and the lower rotating members 36 and 37, the test tube 1 is released from hold by the holding mechanism 15. This releasing operation is performed by pushing the rod 18 into the test tube 1 with the second cylinder 16.

Next, the roller drive mechanism 40 rotates the label attaching roller 38 in a direction indicated by an arrow in FIG. 4. By this rotation, the bar-code label 2 is wound around the external peripheral surface of the test tube 1, and attached to the external peripheral surface of the test tube 1 with the adhesive layer.

The label attaching roller 38 continues to rotate the test tube 1 even after attachment of the bar-code label 2 has been completed. By rotation of the test tube 1, the bar code 2b is read by the bar-code reader 45.

If it is determined that the attaching state of the bar-code label 2 is not defective on the basis of the reading result of the bar-code reader 45, the first and second movable members 31 and 32 are receded in a direction of going away from the test tube 1, by the drive cylinders 33 and 34. Thereby, the test tube 1 is released from the hold by the upper rotating members 35a to 35d and the lower rotating members 36 and 37.

As a result, the test tube 1 with the bar-code label 2 attached is disengaged from the holding mechanism 15 and falls to be received by the holder 3 of the conveying mechanism 5. The test tube 1 held by the holder 3 is conveyed to the next process position by the belt conveyer 6.

If the attaching state of the bar-code label 2 is defective, the recovery box is advanced to the second position in response to a signal from the bar-code reader 45. Therefore, when the test tube 1 is released from hold by the upper rotating members 35a to 35d and the lower rotating members 36 and 37, the test tube 1 falls into the recovery box, and is recovered through a route different from the conveying mechanism 5.

When the test tube 1 is disengaged and falls from the holding mechanism 15, the holding mechanism 15 is receded from the attaching position P1 to the waiting position P2 by operation of the second cylinder 14, and waits for supply of the next test tube 1.

According to the label attaching apparatus 100 having the above structure, it is possible to perform a series of operations, from supply of the test tube 1 to the attaching position P1 to attachment of the bar-code label 2, in the state where the test tube 1 is in the vertically standing attitude. This makes the label attaching apparatus 100 more compact in planar size in comparison with the prior art, and reduces the space necessary for installing the label attaching apparatus 100.

In addition, when the bar-code label 2 is attached to the test tube 1, it suffices to simply move up and down the test tube 1 between the attaching position P1 and the waiting position P2. This obviates the need for means dedicated to conveyance of the test tube 1 for each operation step. Therefore, the structure of the label attaching apparatus is simplified, and thus the cost of facilities can be reduced.

Further, according to the above structure, the holding mechanism 15 of the supplying means 10 holds the test tube 1 to prevent it from falling off and disengages the test tube 1, by simply moving up and down the rod 18 by the second cylinder 16. This simplifies the structure of the holding mechanism 15, and enables secure holding and disengagement of the test tube 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A label attaching apparatus having an attaching position in which a label is attached to an external peripheral surface of a test tube, comprising:
supplying means including a holding mechanism which holds the test tube in a standing attitude, and an elevating mechanism which moves up and down the holding mechanism between the attaching position and a waiting position in which the holding mechanism is receded above from the attaching position;
attaching means for rotating the test tube having been moved down to the attaching position by the supplying means in a circumferential direction of the test tube, and attaching the label to the external peripheral surface of the test tube by winding the label around the external peripheral surface; and
a label supplying mechanism which supplies the label to the attaching means.

2. A label attaching apparatus according to claim 1, wherein
the attaching means includes:
(i) a first movable member and a second movable member which are opposed to each other, with the test tube having been moved down to the attaching position interposed therebetween;
(ii) a plurality of rotating members which are supported by the first and second movable members and hold the test tube therebetween such that the test tube is circumferentially rotatable;
(iii) a label attaching roller which is rotatably supported by the first movable member and is brought into contact with the external peripheral surface of the test tube held by the rotating members; and
(iv) a drive mechanism which circumferentially rotates the label attaching roller, and
the label is supplied between the label attaching roller and the external peripheral surface of the test tube, and thereby the label is wound around the external peripheral surface of the test tube by the label attaching roller.

3. label attaching apparatus according to claim 2, wherein
the label is a bar-code label with a bar code thereon, the second movable member of the attaching means has a bar-code reader which reads the bar code from the test tube, and the bar-code reader determines whether the bar-code label is properly attached to the test tube on the basis of a result of reading the bar code, and outputs a signal to eliminate the test tube, whose attaching state of the bar-code label is defective, on the basis of a result of the determination.

4. A label attaching apparatus according to claim 1, further comprising:
a conveying mechanism provided below the attaching position, the conveying mechanism having a holder which receives the test tube with the label attached, and a conveyer which conveys the holder.

5. A label attaching apparatus according to claim 1, wherein
the holding mechanism includes:
a rod which is removably inserted into the test tube;
a cylinder which axially moves the rod; and
an elastic member which is supported on the rod to be relatively movable in an axial direction of the rod, and has a size insertable into the test tube,
the elastic member is compressed in the test tube and brought into close contact with an internal surface of the test tube such that the test tube is held in the standing attitude, when the rod inserted into the test tube is moved in a direction of being pulled out of the test tube, and the elastic member is released from compression in the test tube and separates from the internal surface of the test tube, when the rod is moved in a direction of being pushed into the test tube.

6. A label attaching apparatus according to claim 1, wherein
the elevating mechanism includes:
an elevating member; and
a cylinder which moves up and down the elevating member at predetermined strokes.

7. A label attaching apparatus according to claim 6, wherein
the holding mechanism includes:
a guide tube which extends downward from the elevating member toward the test tube, and has a fitting portion to be fitted into an opening end of the test tube;
a rod which is to be axially movably inserted into the test tube through the guide tube;
a cylinder which axially moves the rod;
an insertion head which is attached to the rod and inserted into the test tube; and
an elastic member which is supported on the rod to be relatively movable in an axial direction of the rod, has a size insertable into the test tube, and is interposed between the insertion head and the fitting portion,
the elastic member is compressed between the insertion head and the fitting portion and brought into close contact with an internal surface of the test tube such that the test tube is held in the standing attitude, when the rod inserted into the test tube is moved in a direction of being pulled out of the test tube, and the elastic member is released from compression between the insertion head and the fitting portion and separates from the internal surface of the test tube, when the rod is moved in a direction of being pushed into the test tube.

8. A label attaching apparatus according to claim 6, wherein
the holding mechanism includes:
a guide tube which extends downward from the elevating member toward the test tube, and has a fitting portion to be fitted into an opening end of the test tube;
a rod which is to be axially movably inserted into the test tube through the guide tube;
a cylinder which axially moves the rod;
an insertion head which is attached to the rod and inserted into the test tube;
a plurality of elastic members which are supported on the rod to be relatively movable in an axial direction of the rod, have a size insertable into the test tube, and are interposed between the insertion head and the fitting portion; and
a pressing member which is supported on the rod to be relatively movable in the axial direction of the rod, and interposed between the elastic members,
the elastic members are compressed between the insertion head and the pressing member and between the pressing member and the fitting portion, respectively, and brought into close contact with an internal surface of the test tube such that the test tube is held in the standing attitude, when the rod inserted into the test tube is moved in a direction of being pulled out of the test tube, and the elastic members are released from compression between the insertion head and the pressing member and between the pressing member and the fitting portion and separate from the internal surface of the test tube, when the rod is moved in a direction of being pushed into the test tube.
